(19) United States
(12) Patent Application Publication
(10) Pub. No.: US 2009/0187646 A1
(43) Pub. Date: Jul. 23, 2009

(54) IP ADDRESS ASSIGNING METHOD, VLAN CHANGING DEVICE, VLAN CHANGING SYSTEM AND QUARANTINE PROCESS SYSTEM

(75) Inventors: Shuji HOKKYO, Osaka (JP); Shoji FURUCHI, Osaka (JP); Takayuki ITO, Osaka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/413,299

(22) Filed: Mar. 27, 2009

Related U.S. Application Data
(62) Division of application No. 11/166,274, filed on Jun. 27, 2005, now abandoned.

(30) Foreign Application Priority Data
Mar. 17, 2005 (JP) 2005-077369

(51) Int. Cl. G06F 15/177

(52) U.S. Cl. 709/221

(57) ABSTRACT

An IP address assigning method is used for assigning a second IP address to a computer to which a static IP address is assigned in advance. The method includes the steps of storing one temporary IP address and the static IP address of the terminal device in association with each other, and controlling the terminal device to start a communication at the layer 3 regarding the temporary IP address as an IP address of the terminal device itself by notifying the terminal device of the temporary IP address before the terminal device starts the communication at the layer 3.

### CROSS-REFERENCE TO RELATED APPLICATIONS

This application is a Divisional application of Ser. No. 11/166,274, filed Jun. 27, 2005 and claims priority to Japanese Application No. 2005-077369 filed Mar. 17, 2005.

### BACKGROUND OF THE INVENTION

1. Field of the Invention

The present invention relates to a system and a method for changing a virtual local area network (VLAN) to which a computer belongs.

2. Description of the Related Art

In recent years, a problem of computer viruses (hereinafter referred to as “viruses”) has been becoming serious. Many computers have become capable of obtaining data easily from other computers via a network so that infection routes of viruses have expanded, and this is the main reason of the problem. In addition, a defect called a “security hole” of an operating system or a Web browser concerning securities can be another reason of the problem.

Therefore, antivirus software is used widely. This software can remove a virus and prevent infection when the virus has been downloaded to a computer. In addition, a software company distributes a virus definition file to users of the software for dealing with newly discovered viruses.

Companies that provide an operating system or a Web browser are trying to distribute a patch file to users for correcting a security hole promptly upon finding it.

In the case of computers that are used in an office of a government or a company, it is necessary to take measures more effectively for maintaining citizens' or customers' confidence. Many computers may be used in an office, and only one of them may affect other computers if it has a problem of security.

Therefore, a network system called a “quarantine network” is proposed as described in a first document “What is a quarantine network”, N+0 NETWORK Guide, September, 2004, pp. 26-35, Softbank Publishing Company, Sep. 1, 2004, Atsuo Masaki. According to this quarantine network, it is checked whether or not a latest virus definition file or a latest patch file is installed correctly in each computer in an office, for example. Then, if there is found a computer in which the latest virus definition file or the latest patch file is not installed, a necessary file or the like is distributed to the computer so as to remove the problem of security.

If a computer with a problem is found, it is desirable to isolate the computer promptly because the computer may affect other computers as described above.

Therefore, a method for isolating a computer using a dynamic host configuration protocol (DHCP) is proposed as described in a second document “Four methods and forms of quarantine networks”, N+I NETWORK Guide, September, 2004, pp. 36-45, Softbank Publishing Company, Sep. 1, 2004, Takaya Sato, Ken Takahashi, Kouji Nishimura, Yoshitugu Kuroda. According to this method, it is possible to use an existing network environment and to isolate a computer having a problem from a normal business VLAN to a VLAN for isolation. Then, the problem of the computer can be solved by installing a latest virus definition file or the like in the computer on the VLAN for isolation.

When the DHCP method described in the second document is used, and even when an authentication switch method or an IEEE 802.1X method is used, it is necessary to set the computer to accept an IP address that is assigned temporarily by the DHCP as long as the method adopts isolation of the computer from a normal VLAN to another VLAN. Therefore, it is difficult for the DHCP method to isolate a computer that is given a fixed or static IP address.

However, the method of controlling computers by assigning a static IP address to each of them is used very often. In addition, if the computer is a host computer or a server that provides information or services to other computers, the DHCP method is not used ordinarily because the IP address should be fixed.

### SUMMARY OF THE INVENTION

An object of the present invention is to provide a method and a system that can isolate a computer from a normal VLAN to another VLAN when a static IP address is assigned to the computer.

An IP address assigning method according to the present invention is used for assigning to a computer a second IP address instead of a first IP address that is assigned to the computer statically in advance. The IP address assigning method includes the following steps. In order to assign the second IP address to the computer, the second IP address is assigned to the computer by notifying the same before the computer starts communication at the layer 3, a storage portion is made to store the second IP address and the first IP address of the computer in association with each other and the computer is controlled to start the communication at the layer 3 under conditions where the second IP address is used as an IP address of the computer itself. In order to return the IP address of the computer to the first IP address, the computer is controlled to reset a network connection, the computer is notified of the first IP address that corresponds to the second IP address that is assigned to the computer before the computer starts the communication at the layer 3, and the computer is controlled to start the communication at the layer 3 under conditions where the notified first IP address is used as an IP address of the computer itself.

According to the IP address assigning method, another IP address can be assigned to a computer to which an IP address is assigned statically. Therefore, the IP address assigning method can be used preferably for changing a VLAN to which the computer belongs.

Alternatively, a device as described below may be used for changing a VLAN. A VLAN changing device performs a process for changing a VLAN to which a computer belongs from a first VLAN to a second VLAN. The computer is assigned a first IP address statically in advance that is an IP address of the first VLAN. The VLAN changing device includes a first reception portion for receiving first data that the computer has transmitted to other computers, a sender rewriting portion for rewriting sender information that is added to the received first data so as to indicate that a second IP address that is an IP address of the second VLAN is an IP address of a sender of the first data, a first transferring portion for transferring the first data to which the rewritten sender information is added so that a destination computer can receive the first data, an IP address association storing portion for storing an IP address before rewriting the sender information and an IP address after rewriting the same in association with each other, a second reception portion for receiving second data transmitted by another computer, a destination rewriting portion for rewriting destination information so as to indicate that the first IP address corresponding to the second IP address is a destination of the second data if the second IP address is indicated in the destination information that is added to the received second data, and a second transferring portion for transferring the second data to which the rewritten destination information is added so that a device of the destination can receive the second data.

According to the present invention, a computer to which an IP address is assigned statically can be isolated from a normal VLAN to another VLAN. According to one embodiment of the present invention, even if an IP address is assigned statically, a computer having a problem can be isolated to a VLAN for isolation so as to make the computer comply with a security policy securely.

### BRIEF DESCRIPTION OF THE DRAWINGS

FIG. 1 is a diagram showing an example of a general structure of a quarantine network system.

FIG. 2 is a diagram showing an example of a functional structure of a switch with an authentication function.

FIG. 3 is a diagram showing an example of routing permissible information.

FIG. 4 is a diagram showing an example of a functional structure of a policy management server.

FIG. 5 is a diagram showing an example of an IP management table.

FIG. 6 is a diagram showing an example of an IP translation table.

FIG. 7 is a diagram showing an example of a structure of a table management portion.

FIG. 8 is a diagram showing an example of a structure of an IP address translation process portion.

FIG. 9 is a diagram showing an example of a structure of an ARP process portion.

FIG. 10 is a flowchart showing an example of a flow of a process of each device of the quarantine network system during the time period from start of a network function of a terminal device to execution of an inspection process.

FIG. 11 is a flowchart showing an example of a flow of a process of each device of the quarantine network system when a process for curing is executed.

FIGS. 12(a) and 12(b) are diagrams showing an example of ARP response information.

FIGS. 13(a) and 13(b) are diagrams showing an example of a translation process of an IP address.

FIG. 14 is a flowchart showing an example of a flow of a process of each device of the quarantine network system when a temporary IP address is opened.

FIG. 15 is a diagram showing an example of a functional structure of the policy management server.

FIG. 16 is a diagram showing an example of an IP management table.

FIG. 17 is a flowchart showing an example of a flow of a process of each device of the quarantine network system when a process for curing is executed.

FIG. 18 is a flowchart showing an example of a flow of a process of each device of the quarantine network system when a temporary IP address is opened.

### DETAILED DESCRIPTION OF THE PREFERRED EMBODIMENTS

Hereinafter, the present invention will be explained more in detail with reference to embodiments and drawings.

### First Embodiment

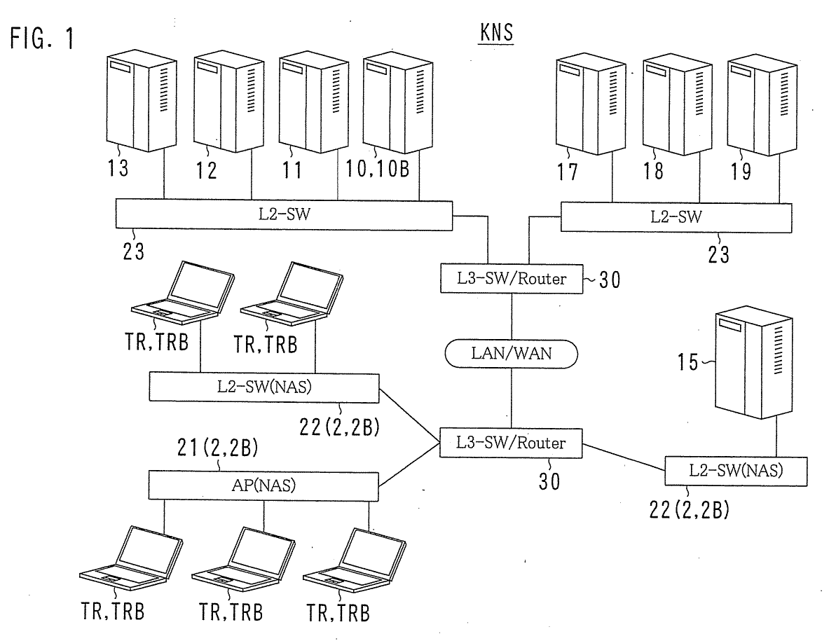

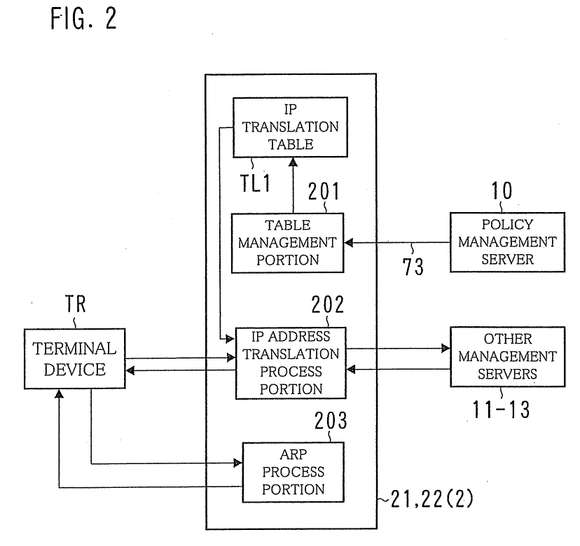

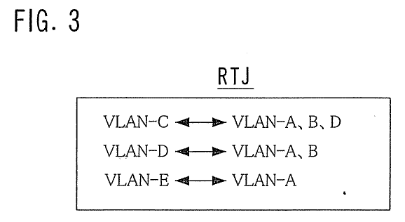

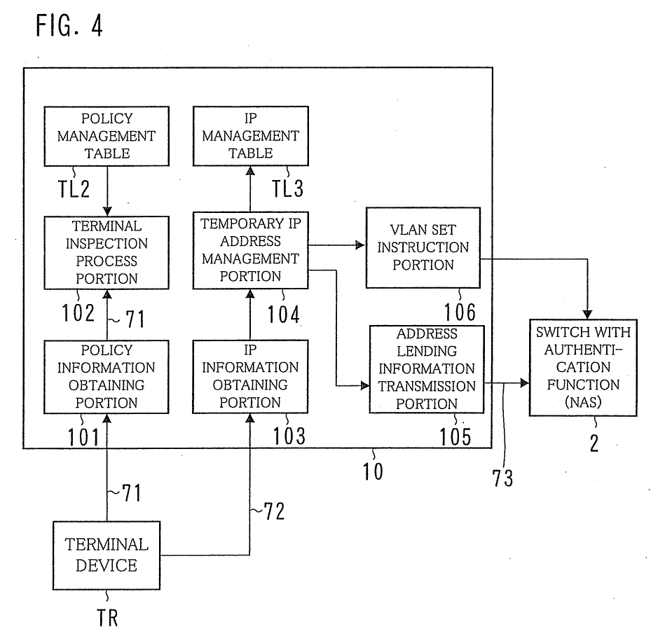

FIG. 1 is a diagram showing an example of a general structure of a quarantine network system KNS, FIG. 2 is a diagram showing an example of a functional structure of a switch with an authentication function 2, FIG. 3 is a diagram showing an example of routing permissible information RTJ, and FIG. 4 is a diagram showing an example of a functional structure of a policy management server 10.

As shown in FIG. 1, the quarantine network system KNS is a network system based on TCP/IP (Transmission Control Protocol/Internet Protocol), and it includes a policy management server 10, a virus management server 11, a patch management server 12, an assets management server 13, a commercial server 15, a RADIUS (Remote Authentication Dial-in User Service) server 17, an LDAP (Lightweight Directory Access Protocol) server 18, and a DHCP (Dynamic Host Configuration Protocol) server 19 and other servers, terminal devices TR, wireless LAN access points 21 for connecting these devices with each other, switches 22 and 23, and a router 30.

The wireless LAN access points 21 and switch 22 are LAN switches for switching in accordance with a MAC address on a layer 2 (a data link layer). However, the wireless LAN access points 21 communicate with the terminal devices TR that have wireless LAN cards, and the switch 22 communicates with the terminal devices TR via cables.

Each of the wireless LAN access points 21 and the switches 22 is equipped with a known network access authentication function. According to this function, a plurality of virtual LANs (hereinafter referred to as a “virtual LAN” or a “VLAN”) can be formed in the quarantine network system KNS, and each of the servers and the terminal devices TR can belong to one of the VLANs. Hereinafter the wireless LAN access point 21 or the switch 22 having this function is generally called a “switch with authentication function 2”.

The switch 23 is a LAN switch for switching in accordance with a MAC address on the layer 2 similarly to the switch 22, but it does not necessarily have the network access authentication function.

It is supposed in this embodiment that there are formed five VLANs including a VLAN-A to which a device for performing a process concerning the quarantine mainly belongs, a VLAN-B to which a device for performing an authentication process or the like at start of access of the terminal device TR mainly belongs, a VLAN-C to which a device such a server for commercial use mainly belongs, a VLAN-D to which a terminal device for commercial use or the like mainly belongs, and a VLAN-E for isolating a device that does not comply with a policy that will be described later.

The policy management server 10, the virus management server 11, the patch management server 12 and the assets management server 13 belong to the VLAN-A. The RADIUS server 17, the LDAP server 18, and the DHCP server 19 belong to the VLAN-B. The commercial server 15 belongs to the VLAN-C, and the terminal devices TR belong to the VLAN-D. Each of the wireless LAN access points 21, the switches 22 and 23, the server and the terminal devices TR is set appropriately so as to belong to the corresponding VLAN. For example, the terminal device TR is set to have one of IP addresses assigned to the VLAN-D, a sub net mask and a default gateway. It is supposed in this embodiment that one of available IP addresses is not lent to the terminal device TR every time like a DHCP method but a predetermined IP address is assigned statically to it. Hereinafter, the IP address that is statically assigned to the terminal device TR is referred to as a “static IP address”.

Moreover, the switch with authentication function 2 is equipped with a table management portion 201, an IP address translation process portion 202, an ARP process portion 203, an IP translation table TL1 and the like as shown in FIG. 2. A part or the whole of these may be realized by circuits as hardware or by a program executed by a CPU as software.

The router 30 is a device (a router or a switch) for routing by the IP addresses on the layer 3 (a network layer). The router 30 of this embodiment is set to have routing permissible information RTJ that indicates relationship to available virtual LANs as shown in FIG. 3. In accordance with this information, plural LANs or WANs are connected to each other. As understood from this routing permissible information RTJ, devices that belong to the VLAN-E can communicate with devices that belong to the VLAN-A by IP communication, but they are prevented from communicating with devices that belong to other virtual LAN via IP communication.

Each of the servers 10-13 including the policy management server 10 and the assets management server 13 performs a process for quarantining each of the terminal devices TR or the servers that are provided to the quarantine network system KNS. Hereinafter, a case will be described where the terminal device TR is quarantined.

The policy management server 10 performs a process for managing several states that include an installation state of a virus definition file or the like as an application program for countermeasure against a computer virus (hereinafter referred to as a “virus” simply) in the terminal device TR, an installation state of a patch file or the like for fixing bugs, removing security holes or improving functions in an operating system (OS), and an installation state of business application programs. In other words, it is checked whether or not the terminal device TR conforms to requirements of security (i.e., a security policy) prescribed in this quarantine network system KNS and whether or not application programs that are necessary for jobs are installed. Then, if the requirements (hereinafter referred to as a “policy”) are not satisfied, the terminal device TR is instructed to install a necessary file or application program. Furthermore, the policy management server 10 also performs a process for isolating the terminal device TR into the VLAN-E.

The virus management server 11 has a virus definition file or the like that is necessary for satisfying an antivirus policy, and it distributes the file to a terminal device TR when receiving a request. The patch management server 12 has a patch file or the like that is necessary for satisfying an OS policy, and it distributes the file to a terminal device TR when receiving a request. The assets management server 13 has an application program or the like that is necessary for satisfying a business policy, and it distributes the program to a terminal device TR when receiving a request.

The commercial server 15 is utilized by a user of the terminal device TR for performing an ordinary business. For example, a file server, a WWW server, a mail server, a database server or the like corresponds to the commercial server 15.

The RADIUS server 17 is a server for performing user authentication by a RADIUS protocol. The LDAP server 18 is a server for performing accesses management by the LDAP protocol. The DHCP server 19 is a server for automatic setting of an IP address or the like for a terminal device TR by a DHCP protocol. In this embodiment, each of the terminal devices TR is assigned a unique IP address (a static IP address) as described above. Therefore, the DHCP server 19 is not used for these terminal devices TR.

The terminal device TR is a personal computer or a workstation having a TCP/IP network function, and an operating system, a business application program, an antivirus application program and the like are installed in the terminal device TR. In addition, a static IP address is assigned to the terminal device TR so that the terminal device TR belongs to the VLAN-D as described above.

A hard disk drive of the policy management server 10 stores programs and data for realizing a policy information obtaining portion 101, a terminal inspection process portion 102, an IP information obtaining portion 103, a temporary IP address management portion 104, an address lending information transmission portion 105, a VLAN set instruction portion 106, a policy management table TL2, an IP management table TL3 and the like as shown in FIG. 4. These programs and data are loaded into a RAM, if necessary, and the programs are executed by a CPU. The servers except the policy management server 10 can be existing ones.

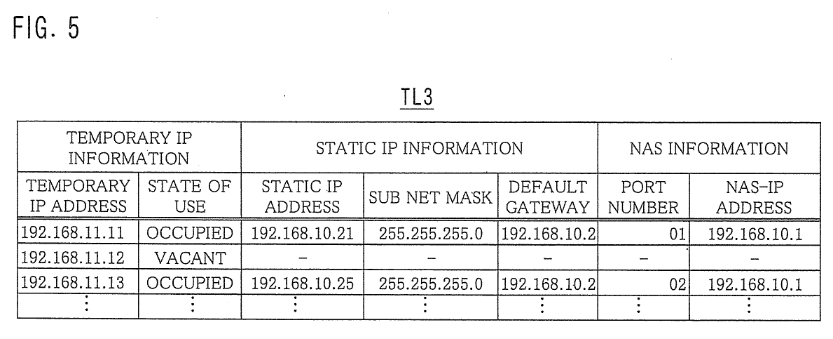

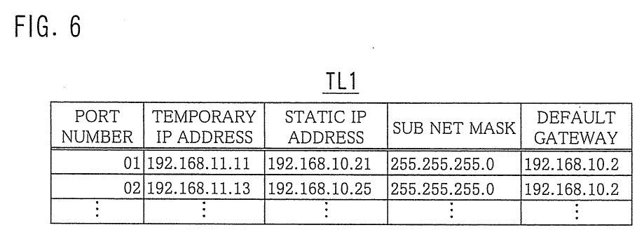

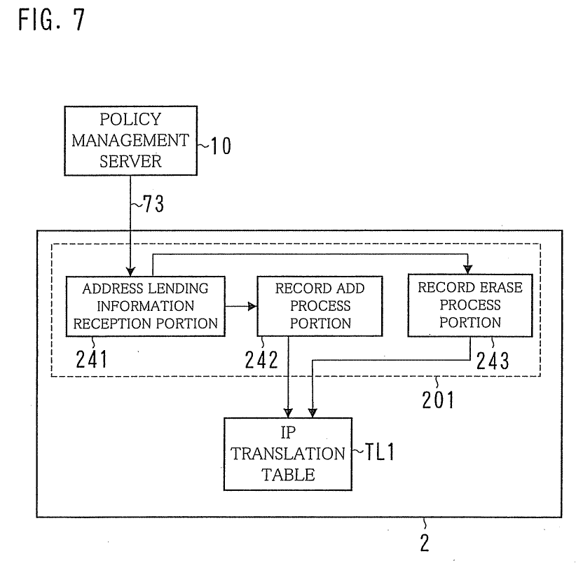

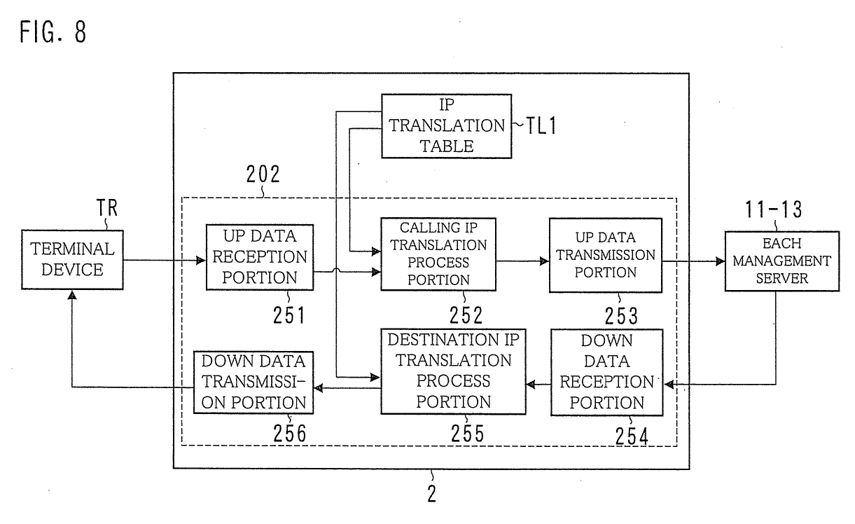

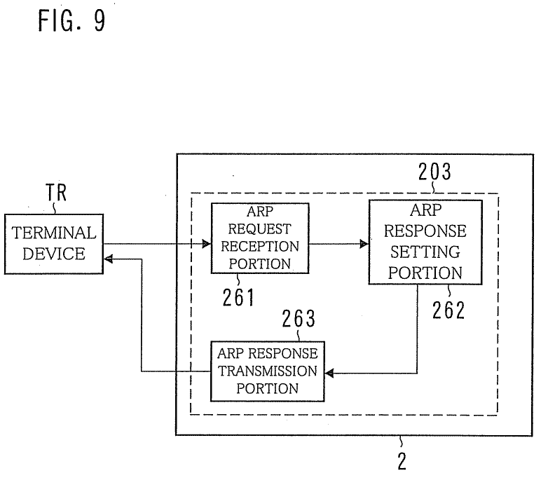

FIG. 5 is a diagram showing an example of the IP management table TL3, FIG. 6 is a diagram showing an example of the IP translation table TL1, FIG. 7 is a diagram showing an example of a structure of the table management portion 201, FIG. 8 is a diagram showing an example of a structure of the IP address translation process portion 202, and FIG. 9 is a diagram showing an example of a structure of the ARP process portion 203.

Next, processes and the like of the policy management server 10 shown in FIG. 4 and the switch with authentication function 2 shown in FIG. 2 will be described.

As shown in FIG. 4, the policy management table TL2 of the policy management server 10 stores information that indicates what type and version of virus definition file, patch file and business application program or the like should be installed in the terminal device TR. In other words, information about the policy of the terminal device TR in the quarantine network system KNS is stored. This information is updated, if necessary, every time when a new virus definition file, a new patch file, a new application program or the like is supplied.

The IP management table TL3 stores a plurality of records including temporary IP information, static IP information and NAS information as shown in FIG. 5. The temporary IP information indicates a temporary IP address and its state of use.

The “temporary IP address” means an IP address that is lent to a terminal device TR temporarily when the terminal device TR is isolated into the VLAN-E, and it is prepared in advance. The “state of use” indicates whether or not the temporary IP address is currently lent to any one of terminal devices TR. If the temporary IP address is lent (i.e., if it is used), a value indicating “occupied” is stored. If it is not lent (i.e., if it is not used), a value indicating “vacant” is stored.

Similarly to the case of the DHCP method, a temporary IP address is lent to a terminal device TR dynamically. Accordingly, it is not always true that the same IP address is lent to the same terminal device TR every time. Further, it is not possible to lend one temporary IP address to plural terminal devices TR simultaneously.

The static IP information indicates a static IP address, a sub net mask and a default gateway of the terminal device TR to which the temporary IP address is lent at present. The NAS information is about the switch with authentication function 2 to which the terminal device TR is connected. The “port number” indicates a port (such as a connector or a channel of the wireless communication) of the switch with authentication function 2 to which the terminal device TR is connected. The “NAS-IP address” is an IP address that is assigned to the switch with authentication function 2.

With reference to FIG. 4 again, the policy information obtaining portion 101 obtains policy information 71 from the terminal device TR via the switch with authentication function 2 or other device. The policy information 71 indicates a type and a version of the virus definition file, the patch file, the business application program and the like that are installed in the terminal device TR currently.

The terminal inspection process portion 102 compares the policy information 71 obtained from the terminal device TR with the policy management table TL2, so as to inspect whether or not the terminal device TR complies with the policy of the quarantine network system KNS. On this occasion, it finds out a portion that does not match the policy. For example, if a version of the virus definition file indicated in the policy information 71 does not match a version indicated in the policy management table TL2, it is determined that the virus definition file does not match the policy.

The IP information obtaining portion 103 obtains IP information 72 from the terminal device TR via the switch with authentication function 2 or other device. The IP information 72 indicates the IP address, the sub net mask, the default gateway and the like that are set in the terminal device TR currently.

The temporary IP address management portion 104 performs a process for management of the temporary IP address including a process for lending a temporary IP address registered in the IP management table TL3 to the terminal device TR and a process for releasing a temporary IP address that becomes unnecessary for lending.

The address lending information transmission portion 105 transmits information about lending the temporary IP address to the switch with authentication function 2. The VLAN set instruction portion 106 provides the switch with authentication function 2 with an instruction for setting affiliation of the terminal device TR with a VLAN.

In FIG. 2, the IP translation table TL1 of the switch with authentication function 2 stores information about the terminal device TR in which the temporary IP address is installed among the terminal devices TR that are connected to the port of the switch with authentication function 2 as shown in FIG. 6. Therefore, it stores information about a port number of the port to which the terminal device TR is connected, a temporary IP address that is assigned to the terminal device TR at present, a static IP address of the terminal device TR, a sub net mask and a default gateway.

The table management portion 201 includes an address lending information reception portion 241, a record add process portion 242 and a record erase process portion 243 as shown in FIG. 7, and it performs a process for management of the IP translation table TL1.

The IP address translation process portion 202 includes an up data reception portion 251, a calling IP translation process portion 252, an up data transmission portion 253, a down data reception portion 254, a destination IP translation process portion 255, and a down data transmission portion 256 as shown in FIG. 8, and it performs a process for changing a calling IP address of a packet transmitted from the terminal device TR to which a temporary IP address is lent and a process for changing a destination IP address of a packet transmitted to the temporary IP address.

The ARP process portion 203 includes an ARP request reception portion 261, an ARP response setting portion 262 and an ARP response transmission portion 263 as shown in FIG. 9, and it performs a process for answering an inquiry about a MAC address of the default gateway. Processes of portions of the table management portion 201, the IP address translation process portion 202 and the ARP process portion 203 will be described one by one later.

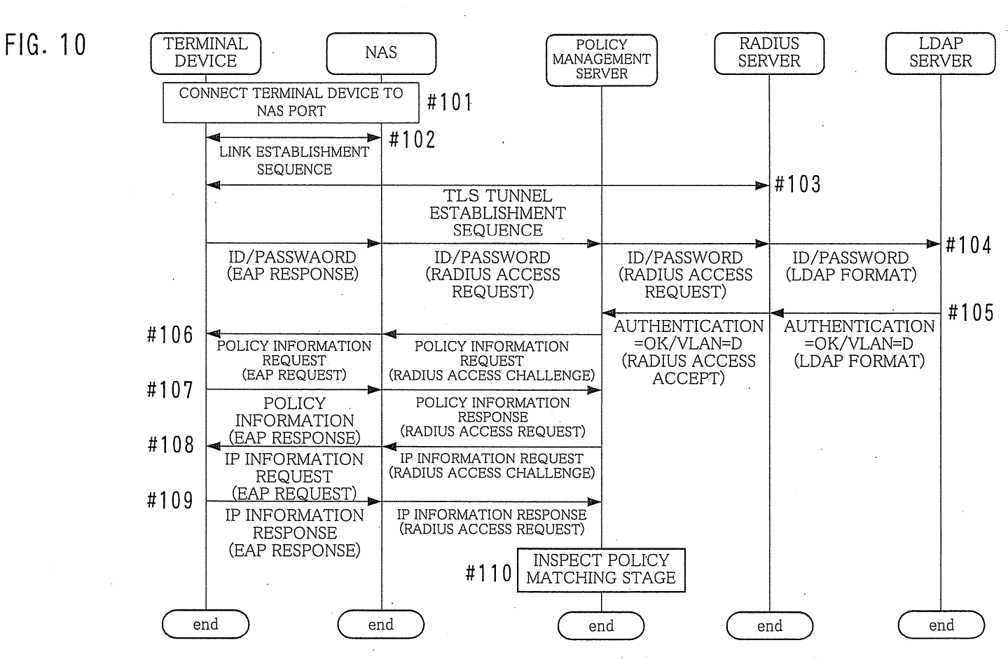

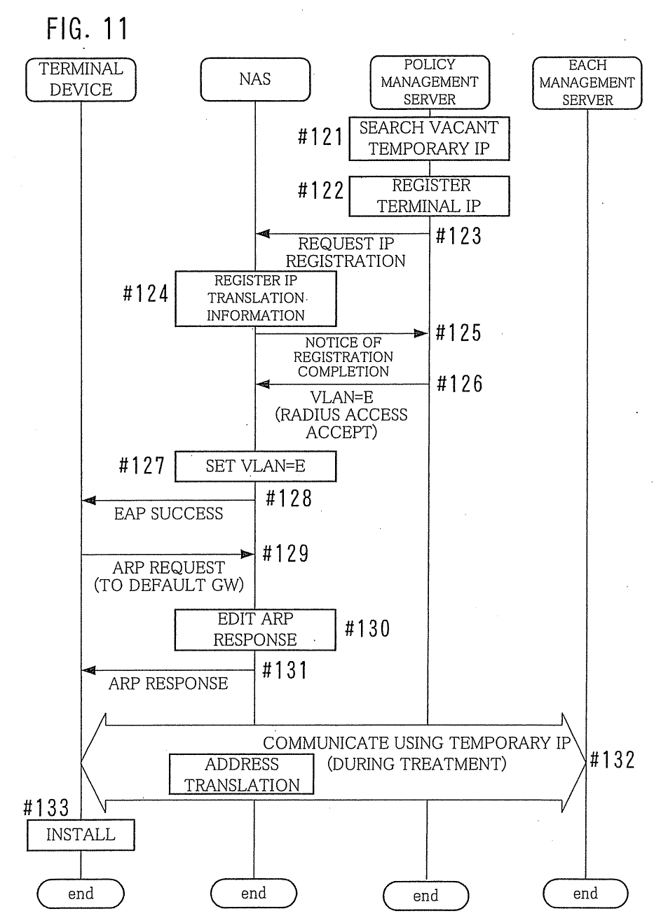

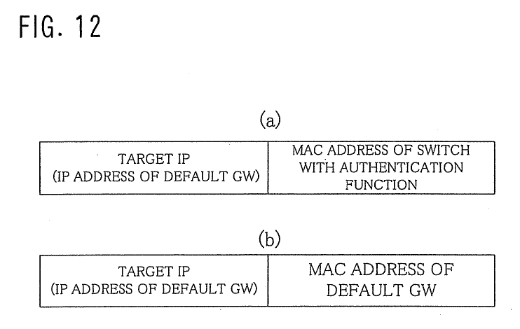

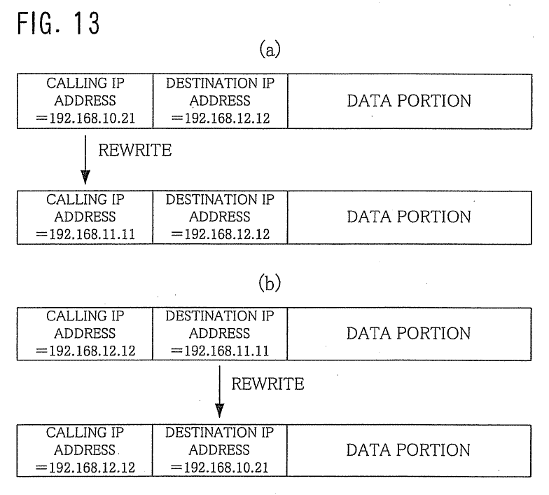

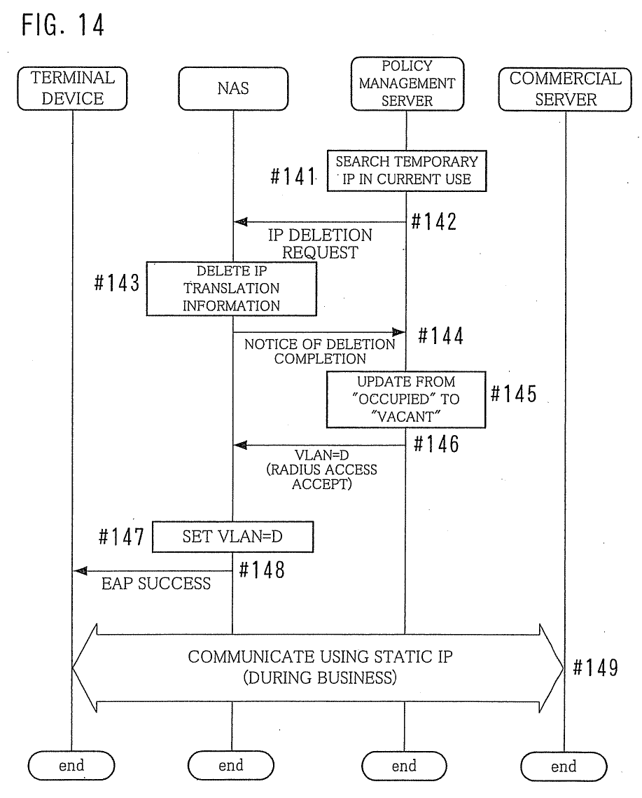

FIG. 10 is a flowchart showing an example of a flow of a process of each device of the quarantine network system KNS during the time period from start of a network function of a terminal device TR to execution of an inspection process, FIG. 11 is a flowchart showing an example of a flow of a process of each device of the quarantine network system KNS when a process for curing is executed, FIGS. 12(a) and 12(b) are diagrams showing an example of ARP response information, FIGS. 13(a) and 13(b) are diagrams showing an example of a translation process of an IP address, and FIG. 14 is a flowchart showing an example of a flow of a process of each device of the quarantine network system KNS when a temporary IP address is opened.

Next, a procedure of a process of each device of the quarantine network system KNS when the quarantine is performed for a terminal device TR will be described with reference to the flowchart.

When the power of the terminal device TR is turned on and the terminal device TR is connected to the switch with authentication function 2 (#101 in FIG. 10), a process of the steps #102-105 is performed similarly to the conventional method. In other words, communication between the terminal device TR and the switch with authentication function 2 is established at the layer 2 level (#102) by performing a process for link establishment (a link establishment sequence prescribed in IEEE802.3 for a wired LAN or a link establishment sequence prescribed in IEEE802.11 for a wireless LAN).

The RADIUS server 17 performs a tunnel establishment sequence by TLS (Transport Layer Security) in EAP (Extensible Authentication Protocol) authentication prescribed in IEEE802.1X, for example (#103). Thus, the communication among the terminal device TR, the switch with authentication function 2, the policy management server 10 and the RADIUS server 17 becomes an encryption communication until EAP success is transmitted to the terminal device TR later.

Information for authentication including a user ID and a password is transmitted from the terminal device TR to the policy management server 10 via the switch with authentication function 2, and it is further transmitted to the RADIUS server 17, the LDAP server 18 and the like (#104). The information for authentication is received by the RADIUS server 17 and the LDAP server 18 by the encryption communication as described above.

Each server that received the information for authentication performs a process for authenticating the terminal device TR and transmits to the policy management server 10 a result of the authentication and VLAN identification information of the terminal device TR corresponding to the user ID (#105).

If a result indicating that the authentication is done successfully is obtained, the policy information obtaining portion 101 of the policy management server 10 (see FIG. 4) obtains the policy information 71 from the terminal device TR. In other words, the policy information 71 is requested from the terminal device TR via the switch with authentication function 2 (#106). Then, the terminal device TR responds to this request and transmits to the policy management server 10 the policy information 71 that indicates a state of the policy application to the terminal device TR itself at present (#107).

In parallel with this or about that time, the IP information obtaining portion 103 of the policy management server 10 obtains the IP information 72 from the terminal device TR. In other words, the IP information 72 is requested from the terminal device TR via the switch with authentication function 2 (#108). Then, the terminal device TR transmits to the policy management server 10 the IP information 72 that indicates the static IP address, the sub net mask, the default gateway and the like of the terminal device TR itself (#109).

The terminal inspection process portion 102 inspects a state of policy matching in the terminal device TR in accordance with the latest policy management table TL2 and the policy information 71 obtained from the terminal device TR (#110).

Responding to a result of the inspection, each device of the quarantine network system KNS performs the following process. If a result indicating that the terminal device TR complies with the policy is obtained, the VLAN set instruction portion 106 of the policy management server 10 permits acceptance of the terminal device TR as a member of the VLAN-D as usual, and it instructs the switch with authentication function 2 to perform setting for it. Then, the switch with authentication function 2 performs setting of VLAN-D to the port to which the terminal device TR is connected, and it transmits the EAP success. Then, after various necessary processes are performed in the same way as the conventional method, the terminal device TR becomes capable of communicating at layer 3 level and becomes a device that belongs to the VLAN-D. Thus, the user will be able to use the terminal device TR for business or the like as usual.

Note that if the authentication is not completed successfully in the process of steps #101-105, the user of the terminal device TR is warned and is requested to enter again the user ID and the password, so that a process for re-authentication is performed. Connection to the VLAN-D is not permitted until the successful result of authentication is obtained.

If a result of inspection indicating that the terminal device TR does not comply with the policy is obtained, the user is warned about it. After that each device of the quarantine network system KNS performs the process for matching the terminal device TR to the policy in the procedure as shown in FIG. 11.

As shown in FIG. 11, the policy management server 10 searches temporary IP addresses that are not used at present (i.e., whose state of use is “vacant”) from the IP management table TL3 (see FIG. 5) (#121), and it lends one of the temporary IP addresses to the terminal device TR. The lending process is performed as follows.

The temporary IP address management portion 104 fills the items of the static IP address, the sub net mask and the default gateway in the record of the unused temporary IP address with the IP information 72 of the terminal device TR obtained in the step #109 in FIG. 10 so as to register them (#122). On this occasion, the switch with authentication function 2 to which the terminal device TR is connected is inquired about a port number of the terminal device TR and an IP address of the switch with authentication function 2 itself, and the result is written in NAS information of the record. Moreover, the state of use is updated from “vacant” to “occupied”. In parallel with the registration process or about that time, the address lending information transmission portion 105 notifies the switch with authentication function 2 that the temporary IP address has been lent to the terminal device TR by transmitting temporary IP lending information 73 that indicates the temporary IP address, a static IP address, a sub net mask, a default gateway and a port number of the terminal device TR. In this case, the terminal device TR is requested to register the temporary IP address (#123).

When the address lending information reception portion 241 (see FIG. 7) of the table management portion 201 receives the temporary IP lending information 73 in the switch with authentication function 2, the record add process portion 242 generates a new record in the IP translation table TL1 (see FIG. 6) and writes contents of the received temporary IP lending information 73 in the record so that the temporary IP address lent to the terminal device TR is registered (#124). Then, a notice about the completion of the registration is sent to the policy management server 10 (#125).

The VLAN set instruction portion 106 of the policy management server 10 instructs the switch with authentication function 2 to set its port so that the terminal device TR belongs to the VLAN-E (#126 and #127). After the setting, the switch with authentication function 2 transmits the EAP success to the terminal device TR (#128).

It is necessary for the terminal device TR to perform IP communication with the virus management server 11, the patch management server 12 and the assets management server 13 for downloading necessary files and application programs so as to comply with the policy. Therefore, it is necessary to know a MAC address of the default gateway for reaching the virtual LAN to which these servers belong. However, the IP address of the default gateway that the terminal device TR recognizes usually is an IP address in a business network, i.e., the VLAN-D. Therefore, the terminal device TR cannot perform the IP communication with these servers in this situation. Thus, the switch with authentication function 2 performs the following process for representing the default gateway.

The terminal device TR requests the switch with authentication function 2 for ARP (Address Resolution Protocol) so as to obtain information about a MAC address of the default gateway (#129). When the ARP request reception portion 261 of the ARP process portion 203 (see FIG. 9) receives the ARP request in the switch with authentication function 2 (#129), the ARP response setting portion 262 refers to the IP translation table TL1 shown in FIG. 6 so as to check whether or not a temporary IP address is lent to the terminal device TR that made the request. If a temporary IP address is lent to the terminal device TR as this time, the ARP response information is set that indicates that the MAC address of the switch with authentication function 2 corresponds to the IP address of the default gateway as shown in FIG. 12(a) (#130). The ARP response transmission portion 263 transmits the ARP response information to the terminal device TR (#131).

The terminal device TR recognizes that the MAC address of the default gateway is the MAC address of the switch with authentication function 2 in accordance with the received ARP response information. Then, the terminal device TR starts communication on the layer 3.

Note that if a temporary IP address is not lent to the terminal device TR, the MAC address of the original default gateway is set in the ARP response information as shown in FIG. 12(b) and transmitted to the terminal device TR.

The terminal device TR starts a process for applying the policy (hereinafter it may referred to as a “treatment” or “curing”) (#132). The treatment is performed as follows, for example.

The terminal device TR requests the virus management server 11, the patch management server 12 and the assets management server 13 for a latest virus definition file, a batch file and a business application program. Then, these servers transmit a file or an application program that is lacking in the terminal device TR.

On this occasion, however, the following process is performed by the IP address translation process portion 202 of the switch with authentication function 2 on the packet that is transmitted and received between the terminal device TR and each server.

When the up data reception portion 251 receives a packet from the terminal device TR (for example, a packet of information requesting a virus definition file) in FIG. 8, the calling IP translation process portion 252 rewrites the IP address of the calling side (the calling IP address) from the static IP address of the terminal device TR to the temporary IP address in accordance with the IP translation table TL1 shown in FIG. 6. For example, if the packet is from the terminal device TR that is connected to the port having a port number “01”, it is rewritten as shown in FIG. 13(a).

The up data transmission portion 253 transfers the packet in which the calling IP address is transformed to the default gateway (L3-SW/Router) of the switch with authentication function 2 itself in accordance with the destination IP address on the packet. Then, the packet is received by the destination server via the default gateway and other nodes.

The server that received the packet recognizes that the packet has been transmitted from a device that belongs to the VLAN-E. Then, it transmits a file, an application program and the like that are necessary for the treatment to the calling IP address of the received packet in the same way as the conventional method. Here, a temporary IP address is used as the calling IP address of the received packet, so the file and the application program are relayed by the switch with authentication function 2.

When the down data reception portion 254 receives the packet of the file or the application program that is transmitted from the server, the destination IP translation process portion 255 rewrites the IP address of the destination (the destination IP address) from the temporary IP address of the terminal device TR to the static IP address in accordance with the IP translation table TL1. For example, if the destination IP address received from the server is “192.168.11.11”, it is rewritten into “192.168.10.21” as shown in FIG. 13(b). Then, the down data transmission portion 256 transfers the packet in which the destination IP address is transformed to the terminal device TR.

In this way, according to the translation process of the IP address by the IP address translation process portion 202, the devices including the virus management server 11, the patch management server 12 and the assets management server 13 apparently have setting of a temporary IP address as the IP address of the terminal device TR.

With reference to FIG. 11 again, the terminal device TR receives necessary files, application programs and the like from the virus management server 11, the patch management server 12 and the assets management server 13, so as to install them (#133). In addition, if a virus is found in the terminal device TR, the virus is removed. Thus, the curing process is completed.

After the curing process, the terminal device TR is restarted if necessary. Then, it is inspected again whether the virus definition file or the like is installed correctly or not. The procedure of the inspection process is as described above with reference to FIG. 10.

If it is decided that the terminal device TR complies with the policy correctly as a result of this reinspection, the policy management server 10 and the switch with authentication function 2 perform a process for letting the terminal device TR belong again to the normally belonging virtual LAN, i.e., the VLAN-D in the procedure as shown in FIG. 14.

When the policy management server 10 receives the notice indicating that the terminal device TR complies with the policy correctly, it searches a temporary IP address that is lent to the terminal device TR in accordance with the IP management table TL3 (see FIG. 5) (#141 in FIG. 14). The switch with authentication function 2 is notified of the searched temporary IP address and is requested to erase the temporary IP address (#142).

The record erase process portion 243 (see FIG. 7) of the switch with authentication function 2 searches a record of the temporary IP address that is notified by the policy management server 10 from the IP translation table TL1 (see FIG. 6) and deletes the record (#143). After the deletion is completed, the policy management server 10 is notified of the completion of deletion (#144).

When the policy management server 10 receives a notice from the switch with authentication function 2, the static IP information and the NAS information that are stored in the IP management table TL3 and are associated with the temporary IP address are deleted, and the state of use is updated from “occupied” to “vacant” (#145).

The policy management server 10 instructs the switch with authentication function 2 to set its port so that the terminal device TR belongs to the VLAN-D (#146 and #147). After the setting, the switch with authentication function 2 transmits the EAP success to the terminal device TR (#148).

Then, the terminal device TR receives the EAP success and performs various necessary processes similarly to the conventional method. After that, it starts communication at the layer 3 level. Thus, the terminal device TR becomes a device that belongs to the VLAN-D, and the user can use the terminal device TR for business by connecting it with the commercial server 15 or the like (#149).

Note that the terminal device TR becomes in the state where no temporary IP address is lent after the process in steps #143 and #147. Therefore, the switch with authentication function 2 does not perform the process for changing the MAC address shown in FIGS. 9, 12(a) and 12(b) as well as the translation process of the IP address on a packet shown in FIGS. 8, 13(a) and 13(b).

According to this embodiment, a terminal device TR that does not comply with the policy can be isolated to the VLAN-E for treatment without changing setting about the IP address or the like in the terminal device TR.

### Second Embodiment

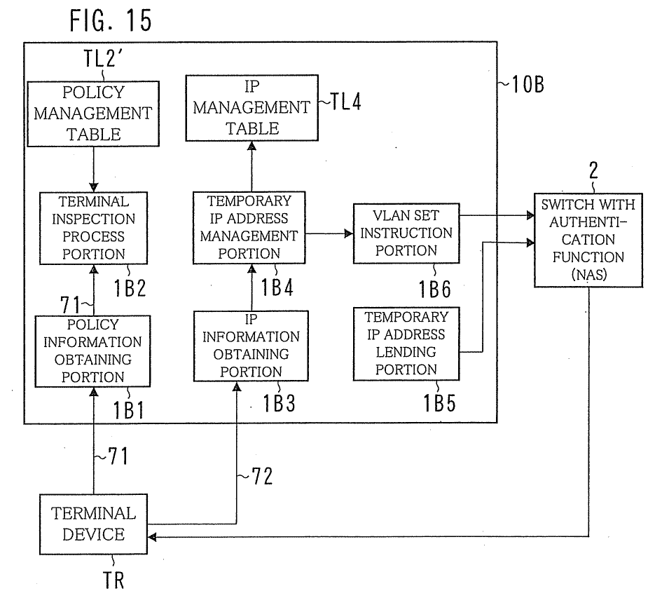

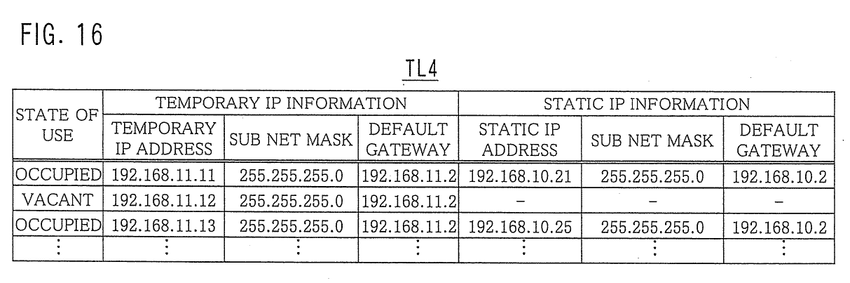

FIG. 15 is a diagram showing an example of a functional structure of a policy management server 10B, and FIG. 16 is a diagram showing an example of an IP management table TL4.

In the first embodiment, as shown in FIGS. 8, 13(a) and 13(b), the switch with authentication function 2 performs the translation process of the IP address on a packet, so that the temporary IP address is assigned to the terminal device TR indirectly. In the second embodiment, the temporary IP address is set and assigned to the terminal device TR directly.

The general structure of the quarantine network system KNS in the second embodiment is basically the same as that in the first embodiment shown in FIG. 1. However, the policy management server 10, the switch with authentication function 2 and the terminal device TR have different functional structures and different process contents. Hereinafter, the differences will be described mainly. Description of the same portions as the first embodiment will be omitted. Note that the policy management server, the switch with authentication function and the terminal device in the second embodiment are discriminated from those in the first embodiment by referring to as a “policy management server 10B”, a “switch with authentication function 2B” and a “terminal device TRB”, respectively.

The switch with authentication function 2B has a function of setting its port so that the terminal device TRB belongs to one of the VLAN-A through the VLAN-E in accordance with an instruction from the policy management server 10B. The functions of the table management portion 201, the IP address translation process portion 202, the ARP process portion 203 and the IP translation table TL1 described in the first embodiment are not necessary.

Programs and data are installed in the hard disk drive of the policy management server 10B for realizing functions of a policy information obtaining portion 1B1, a terminal inspection process portion 1B2, an IP information obtaining portion 1B3, a temporary IP address management portion 1B4, a temporary IP address lending portion 1B5, a VLAN set instruction portion 1B6, a policy management table TL2′ and an IP management table TL4 as shown in FIG. 15.

The policy information obtaining portion 1B1, the terminal inspection process portion 1B2, the IP information obtaining portion 1B3, the temporary IP address management portion 1B4, the VLAN set instruction portion 1B6 and the policy management table TL2′ perform the same processes as the policy information obtaining portion 101, the terminal inspection process portion 102, the IP information obtaining portion 103, the temporary IP address management portion 104, the VLAN set instruction portion 106 and the policy management table TL2 (see FIG. 4) in the first embodiment, respectively.

The temporary IP address lending portion 1B5 performs a process for lending a temporary IP address to the terminal device TRB that was decided not to comply with the policy by the inspection, so that the terminal device TRB is isolated into the VLAN-E.

The IP management table TL4 stores information about the temporary IP address or the like that is lent to the terminal device TRB for isolating the same to the VLAN-E as shown in FIG. 16. The “temporary IP information” indicates a temporary IP address that is the target of the lending as well as a sub net mask and a default gateway to be set to the terminal device TRB together with the temporary IP address. The “state of use” indicates whether the temporary IP address is currently used (lent) or not. The “static IP information” indicates a static IP address, a sub net mask and a default gateway of the terminal device TRB to which the temporary IP address is lent currently.

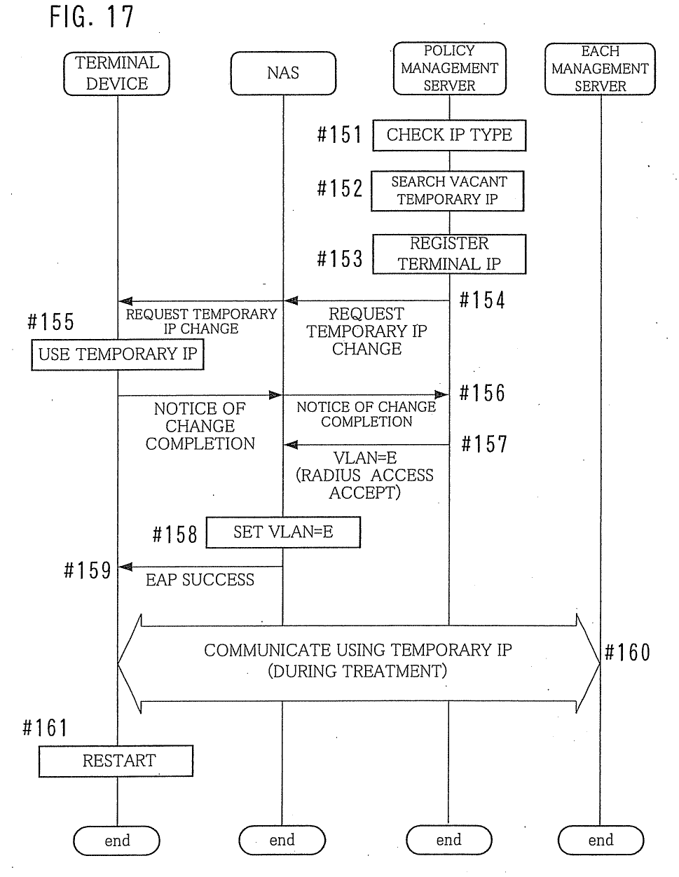

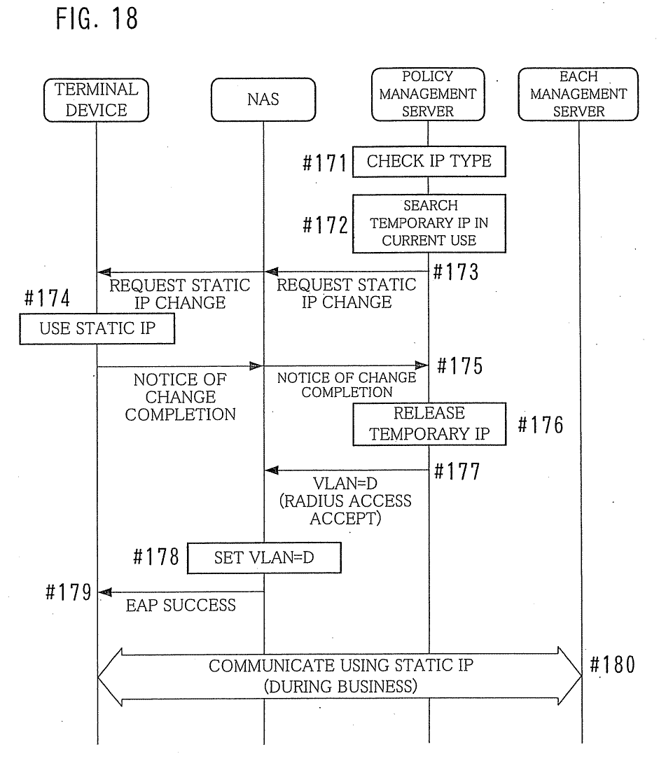

FIG. 17 is a flowchart showing an example of a flow of a process of each device of the quarantine network system KNS when a process for curing is executed, and FIG. 18 is a flowchart showing an example of a flow of a process of each device of the quarantine network system KNS when a temporary IP address is opened.

Next, procedures of processes will be described that are performed by devices of the quarantine network system KNS when the quarantine of the terminal device TRB is performed in the second embodiment, with reference to the flowcharts.

The flow of the process until the inspection of the terminal device TRB is the same as that in the first embodiment, which was explained above with reference to FIG. 10.

Note that in the process shown in FIG. 10, the policy management server 10B obtains the policy information 71 that indicates an installation state of the virus definition file or the like in the terminal device TRB and the IP information 72 that indicates the IP address or the like. In addition, communication between the terminal device TRB and the switch with authentication function 2B is still the layer 2 level when the process shown in FIG. 10 ends.

If it is decided that the terminal device TRB does not comply with the policy as a result of the inspection, the terminal device TRB is isolated to the VLAN-E for treatment. In the second embodiment, the devices of the quarantine network system KNS perform these processes by following the procedure shown in FIG. 17.

The policy management server 10B checks whether the IP address that is set in the terminal device TRB at present is a static IP address or a temporary IP address in accordance with the IP information 72 of the terminal device TRB (#151 in FIG. 17). If the static IP address is set, the terminal device TRB belongs to the VLAN-E and does not perform the IP communication.

Therefore, the policy management server 10B searches one of temporary IP addresses that are not lent at present (i.e., in which the state of use is “vacant”) from the IP management table TL4 shown in FIG. 16 (#152), and it lends the temporary IP address to the terminal device TRB (#153). On this occasion, the temporary IP address is associated with the static IP address or the like of the terminal device TRB in the IP management table TL4, and the state of use is updated from “vacant” to “occupied”.

In parallel with the process in the step #153 or about that time, the policy management server 10B notifies the terminal device TRB of the lent temporary IP address and the corresponding sub net mask and default gateway via the switch with authentication function 2B, so as to request the same to use the temporary IP address or the like (#154).

The terminal device TRB uses the temporary IP address, the sub net mask and the default gateway that were notified from the policy management server 10B as a network setting of the terminal device TRB itself (#155). In other words, if the OS of the terminal device TRB is Windows (registered trademark) for example, the temporary IP address, the sub net mask and the default gateway are written to the IP address information on the registry. Thus, the IP address of the terminal device TRB is changed from the static IP address to the temporary IP address. Then, the terminal device TRB notifies the policy management server 10B of completion of application of the temporary IP address via the switch with authentication function 2B (#156).

The policy management server 10B instructs the switch with authentication function 2B to set its port so that the terminal device TRB belongs to the VLAN-E (#157 and #158). The switch with authentication function 2B transmits the EAP success to the terminal device TRB (#159).

The terminal device TRB receives the EAP success and performs various necessary processes similarly to the conventional method. Then, the terminal device TRB starts the communication at layer 3 level. Thus, the terminal device TRB becomes a device that belongs to the VLAN-E. Then, a file, an application program or the like is downloaded from the virus management server 11, the patch management server 12 and the assets management server 13 if necessary. The file or the application program is used for treatment (#160). After the treatment, the terminal device TR is restarted so as to perform reset of the current communication or the like (#161).

After the restart of the terminal device TRB, similarly to the case of the first embodiment, it is inspected again whether or not a virus definition file or the like is installed in the terminal device TRB correctly by following the procedure shown in FIG. 10.

If it is decided that the policy is applied correctly as a result of the inspection, the policy management server 10B and the switch with authentication function 2B perform a process for making the terminal device TRB belong to the normal virtual LAN, i.e., the VLAN-D by following the procedure as shown in FIG. 18.

The policy management server 10B checks whether the IP address set in the terminal device TRB at present is a static IP address or a temporary IP address in accordance with the IP information 72 of the terminal device TRB (#171 in FIG. 18). Here, it is understood that the temporary IP address is still set. Therefore, the policy management server 10B starts the process for returning the IP address of the terminal device TRB to the static IP address.

The temporary IP address set in the terminal device TRB at present is searched from the IP management table TL4 shown in FIG. 16 (#172). The static IP address, the sub net mask and the default gateway that are associated with the temporary IP address are notified to the terminal device TRB via the switch with authentication function 2B, so that the terminal device TRB is requested to use the static IP address or the like (#173).

The terminal device TRB uses the static IP address, the sub net mask and the default gateway that are notified by the policy management server 10B as a network setting of the terminal device TRB itself (#174). In other words, if the OS of the terminal device TRB is Windows for example, the temporary IP address or the like is written to the IP address information on the registry as described above. In this way, the IP address of the terminal device TRB is changed to the static IP address. Then, the terminal device TRB notifies the policy management server 10B of completion of application of the static IP address via the switch with authentication function 2B (#175).

When the policy management server 10B receives the notification, it deletes the static IP information from the record of the temporary IP address that had been lent to the terminal device TRB (see FIG. 16) and updates the state of use from “occupied” to “vacant” (#176). Thus, the temporary IP address is released. The switch with authentication function 2B is instructed to set its port so that the terminal device TRB belongs to the VLAN-D (#177 and #178). The switch with authentication function 2B transmits the EAP success to the terminal device TRB (#179).

Then, the terminal device TRB receives the EAP success and performs various necessary processes similarly to the conventional method. After that, it starts communication at the layer 3 level. Thus, the terminal device TRB becomes a device that belongs to the VLAN-D. The user can connect the terminal device TRB to the commercial server 15 or the like so as to use it for business (#180).

According to the second embodiment, it is possible to apply an IP address of the VLAN-E to the terminal device TR to which an IP address of the VLAN-D is given statically.

Although the case where the terminal device TR is quarantined is described above as the first and the second embodiments, it is also possible to apply the present invention to quarantine a server such as the commercial server 15 or other communication device.

Furthermore, the structure of the whole or a part of the quarantine network system KNS, the policy management server 10, the switch with authentication function 2, the process contents thereof, the order of processes and contents of the tables can be modified in accordance with the spirits of the present invention if necessary.

The present invention can be utilized particularly for isolating a terminal device and a server in a network system in which a dynamic host configuration protocol (DHCP) cannot be used.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A VLAN changing device for performing a process for changing a VLAN to which a computer belongs from a first VLAN to a second VLAN, the computer being assigned a first IP address statically in advance that is an IP address of the first VLAN, the VLAN changing device comprising:
a first reception portion for receiving first data that the computer has transmitted to other computers;
a sender rewriting portion for rewriting sender information that is added to the received first data so as to indicate that a second IP address that is an IP address of the second VLAN is an IP address of a sender of the first data;
a first transferring portion for transferring the first data to which the rewritten sender information is added so that a destination computer can receive the first data;
an IP address association storing portion for storing an IP address before rewriting the sender information and an IP address after rewriting the same in association with each other;
a second reception portion for receiving second data transmitted by another computer;
a destination rewriting portion for rewriting destination information so as to indicate that the first IP address corresponding to the second IP address is a destination of the second data if the second IP address is indicated in the destination information that is added to the received second data; and
a second transferring portion for transferring the second data to which the rewritten destination information is added so that a device of the destination can receive the second data.

2. A VLAN changing system for changing a VLAN to which a computer belongs from a first VLAN to a second VLAN, the computer being assigned a first IP address statically in advance that is an IP address of the first VLAN, the VLAN changing system comprising:
a server for managing a second IP address that is an IP address of the second VLAN; and
a relaying device for relaying data that are sent and received between the computer and a device that is another party of communication;
the server including
a lent IP address storing portion for storing one or more second IP addresses in association with the first IP address of the computer to which the second IP address is lent, and
an IP address lending portion for lending the second IP address to the computer whose belonging is changed to the second VLAN by notifying the relaying device of one of the second IP addresses that are not lent at present; and
the relaying device including
a sender rewriting portion for rewriting sender information that is added to data to be relayed and transmitted from the computer to the device of the other party of communication so as to indicate that the IP address of a sender of the data is the second IP address if the second IP address is lent from the server to the computer,
an IP address association storing portion for storing an IP address before rewriting the sender information in association with an IP address after rewriting the same, and
a destination rewriting portion for rewriting destination information so as to indicate that the IP address of a destination of the data is the first IP address corresponding to the second IP address if the second IP address is indicated in the destination information that is added to the data to be relayed and transmitted from the device of the other party of communication.

3. The VLAN changing system according to claim 3, wherein in order to return the VLAN to which the computer belongs from the second VLAN to the first VLAN, the sender rewriting portion stops the process of rewriting the destination information that is added to the data transmitted by the computer to be relayed, and the first IP address that is associated with the second IP address lent to the computer is deleted from the lent IP address storing portion and the IP address association storing portion.

4. A VLAN changing system for changing a VLAN to which a computer belongs from a first VLAN to a second VLAN, the computer being assigned a first IP address statically in advance that is an IP address of the first VLAN, the VLAN changing system comprising:
a lent IP address storing portion for storing a second IP address that is an IP address of the second VLAN in association with the first IP address of the computer to which the second IP address is lent;
an IP address lending portion for lending one of the second IP addresses that are not lent at present to the computer whose belonging is changed to the second VLAN by notifying the same before the computer starts communication at the layer 3 (network layer); and
a control portion for letting the computer start the communication at the layer 3 (network layer) under conditions where the lent second IP address is used as an IP address of the computer itself.

5. The VLAN changing system according to claim 5, wherein in order to return the VLAN to which the computer belongs from the second VLAN to the first VLAN, the lent IP address storing portion deletes the first IP address that is associated with the second IP address lent to the computer, and the control portion makes the computer reset communication and start communication at the layer 3 under conditions where the first IP address of the computer is used as an IP address of the computer itself.
